(19) United States
(12) Patent Application Publication
(10) Pub. No.: US 2006/0090189 A1
(43) Pub. Date: Apr. 27, 2006

(54) Device for receiving a signal containing text information that can be used for programming the reception

(75) Inventor: Thomas Gruber, Gols (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/535,289

(22) PCT Filed: Oct. 31, 2003
(86) PCT No.: PCT/IB03/04919

§ 371 Date: May 17, 2005

(30) Foreign Application Priority Data
Nov. 22, 2002 (EP) 02102622.4

(51) Int. Cl. H04N 7/173

(52) U.S. Cl. 725/120

(57) ABSTRACT

In a device (1) for receiving a signal (S) that can be received via a selectable reception channel, which signal (S) represents visually presentable video information (VI) and text information (TI) contained in the visually presentable video information (VI), firstly, reception stage (12) is provided, which is designed for the channel-selective reception of the signal (S) in a controllable manner as a function of control information (CI) that can be supplied to the reception stage (12), and, further, an extraction stage (17) is provided, to which the video information (VI) can be sent and which is designed to extract the text information (TI) contained in the visually presentable video information (VI), and, further, programming stage (20) is provided, which, using the extracted text information (TI), is designed for the programmable provision of the control information (CI) for the reception stage (12).

The invention relates to a device for receiving a signal that can be received via a selectable reception channel, which signal represents video information and text information, wherein reception means, which are designed for the channel-selective reception of the signal in a controllable manner as a function of control information, which can be generated using the text information, are provided.

The invention further relates to a method for receiving a signal that can be received via a selectable reception channel, which signal represents video information and text information, wherein, using reception means, the signal is received channel-selectively, in a controllable manner, as a function of control information generated using the text information and supplied to the reception means.

A device of this kind, of the generic type specified in the first paragraph, and a method of this kind, of the generic type specified in the second paragraph are known from document US 2002/0073422 A1.

The known device, with which the known method can be implemented, takes the form of a television set, which is equipped with reception means designed for the channel-selective reception of a signal assigned to a reception channel, namely a television signal. In addition to visually presentable video information, such as an entertainment program, text information that is not contained in the visually presentable video information is transmitted with the aid of the signal, taking the form of teletext information, which is known to be transmitted in the vertical blanking interval of the television signal separately from the visually presentable video information. With the aid of the teletext information, information is supplied regarding video information that will in future be capable of reception with the television signal, which information may concern, for example, a title, a date, a reception channel, a transmission time, a description and a duration of the particular program. The device is further equipped with programming means, which are designed for the programmable provision, using the teletext information, of the control information for the reception means, so video information that will be receivable in the future can be received automatically, at the correct moment and with selection of the correct reception channel, without any intervention by a user of the device.

In the case of the known device and the known method, a first problem consists in the fact that suitable teletext information for programming the reception means is not always available because no generally applicable standard exists for the supplying of teletext information appropriate for programming, and therefore the manner in which this teletext information is supplied, and whether it is supplied at all, depends on the goodwill of a broadcasting station responsible for a particular reception channel. A second problem consists in the fact that the teletext information appropriate and useable for programming would have to be identified in order to distinguish it simply and quickly from other teletext information. A third problem is that the teletext information appropriate and useable for programming may in some circumstances have a relatively great data volume, and compression of this teletext information would therefore be expedient in order to render the teletext information relatively quickly available, which would further require a knowledge of the appropriate compression of the teletext information in order to be able to use it for programming. By analogy with the above-mentioned first problem, there is no uniform solution, such as a standard with which these problems of the arbitrary nature of a broadcasting station would be solved, for the other two above-mentioned problems either. A further problem exists in that the teletext information is unfortunately relatively frequently subject to interference and therefore unusable for programming. As a result, the desired programmed reception of video information that will be receivable in the future using the teletext information is not ensured with sufficient reliability with the known device.

It is the object of the invention to eliminate the above-mentioned problems in a device of the generic type specified above in the first paragraph and in a method of the generic type specified above in the second paragraph, and to create an improved device and an improved method.

To achieve the above-mentioned object, in a device in accordance with the invention, features in accordance with the invention are provided, so that a device in accordance with the invention can be characterized in the following manner, namely:

Device for receiving a signal that can be received via a selectable reception channel, which signal represents visually presentable video information and text information contained in the visually presentable video information, wherein reception means are provided, which are designed for the channel-selective reception of the signal in a controllable manner as a function of control information that can be supplied to the reception means, and wherein downstream of the reception means are provided processing means, which are designed to process the received signal and to provide the video information and the text information, and wherein the processing means are equipped with extraction means, which are designed to extract the text information from the visually presentable video information, and wherein programming means are provided, which are located downstream of the extraction means and, using the extracted text information, are designed for the programmable provision of the control information for the reception means.

To achieve the above-mentioned object, in a method in accordance with the invention, features in accordance with the invention are provided, so that a method in accordance with the invention can be characterized in the following manner, namely:

Method for receiving a signal that can be received via a selectable reception channel, which signal represents visually presentable video information and text information contained in the visually presentable video information, wherein, using reception means, the signal is received channel-selectively, in a controllable manner, as a function of control information supplied to the reception means, and wherein the signal is processed by processing means located downstream of the reception means, and the video information and the text information are supplied, and wherein the text information is extracted from the supplied visually presentable video information by extraction means contained in the processing means, and wherein the control information for the reception means is provided programmably by the programming means located downstream of the extraction means, using the extracted text information.

The provision of the measures in accordance with the invention gives rise to the advantage that the text information that can be used for programming can be obtained directly from visually presentable, and therefore visually perceptible, video information. Video information of this kind may be an insertion of textual information in, for example, a preview—known as a trailer—of a video film. This give rise to the further advantage that the text information is available irrespective of the presence of teletext information or of any problems associated with a teletext system, and, above all, is always present in plain text, i.e. not encrypted or specially coded, which greatly simplifies the processing of text information of this kind. The further advantage is obtained that the text information is actually available in real-time as a component of the video information, and, as such, is also perceived visually as an integral component of the video information by a user, which user may have to decide whether, in the future, he would in fact wish to receive with the device the particular future video information announced. The further advantage is obtained that the text information is generally available with the normally good picture quality of video information, and therefore generally shows virtually no distortion that would impair the processing of the text information. Should a picture distortion of this kind occur, however, the advantage exists with the solution in accordance with the invention that this picture distortion is also perceived visually by a user, and the user is made aware or warned, solely through his perception of the picture distortion, that the text information used for the programming may not have been received and processed correctly.

With the solutions in accordance with the invention, it has further proved advantageous if, in addition, the features as claimed in claim 2 and claim 8 are provided. This gives rise to the advantage that, rather than the entire video information being used for extraction of the text information, it is just one individual picture of the video information or multiple pictures occurring one after another but not necessarily immediately in succession that are used, which, from the processing viewpoint, is significantly easier to deal with than a continuous succession of pictures. As a result, the further advantage is obtained that recourse may even be had to a picture of the video information containing the text information that occurred in the past, which is to be used for the programmable provision of the control information for the reception means, although the currently available video information may already no longer contain any useable text information. In particular, where multiple pictures are present, the advantage is obtained that, during the extraction of text information, account can be taken of the particular picture that is the most suitable, as regards the text information contained within it, for the purposes of the programming means. A further advantage where multiple pictures are present is that textual information, distributed over a plurality of pictures, can be combined to form the text information that is to be used for the programmable provision of the control information for the reception means.

With the solutions in accordance with the invention, it has further proved advantageous if, in addition, the features as claimed in claim 3 and claim 9 are provided. This gives rise to the advantage that the text information that can be used for the purposes of the programming means can be distinguished in a simple, precise manner from non-useable textual information. In particular, it has proved advantageous if the text specimens concern date information or date-information formats that directly allow conclusions to be drawn about the particular useable date, or indirectly allow conclusions to be drawn about the particular useable date, as in the case of such textual information as “TODAY”, “TOMORROW” or “AT CHRISTMAS”. It has further proved advantageous if the text specimens concern time information or time-information formats that directly allow conclusions to be drawn about the particular useable period or moment, or indirectly allow conclusions to be drawn about the particular useable period or moment, as in the case of such textual information as “PRIME TIME”, “a.m.”, “p.m.” or “AFTER THE NEWS”.

With the solutions in accordance with the invention, it has further proved advantageous if, in addition, the features as claimed in claim 4 and claim 10 are provided. This gives rise to the advantage that even text information that is incomplete for the purpose of the programming means, which may have been caused by, for instance, distorted video information, or by text information that was incomplete from the outset, or, when filtering the pictures, by text information that can be filtered to only a limited extent owing to technical difficulties, will deliver complete text information to the programming means without any intervention on the part of a user of the device.

With the solutions in accordance with the invention, it has further proved advantageous if, in addition, the features as claimed in claim 5 and claim 11 are provided. This gives rise to the advantage that, at a well defined moment, such as when a user of the device sees a trailer for a video film in which the text information necessary for programming is inserted as a component of the visually presented video information at a specific moment or during a time span, the activation information is sent by a user of the device to the device or the extraction means, and, virtually synchronously with the picture or picture sequence of the trailer visually perceived by the user, the text information for the programming means is extracted from the video information or from the particular picture or the particular picture sequence containing the text information.

With the solutions in accordance with the invention, it has further proved advantageous if, in addition, the features as claimed in claim 6 and claim 12 are provided. This gives rise to the advantage that, for checking purposes for a user, following on from the extraction of the text information and the reception of the extracted text information by the programming means, the text information that is useable or has already been used by the programming means is available to the user of the device as an insertion, self-generated by the device, into the video information visually presented to the user.

The above aspects and further aspects of the invention are explained below.

The invention will be further described with reference to examples of embodiments shown in the drawings, to which, however, the invention is not restricted.

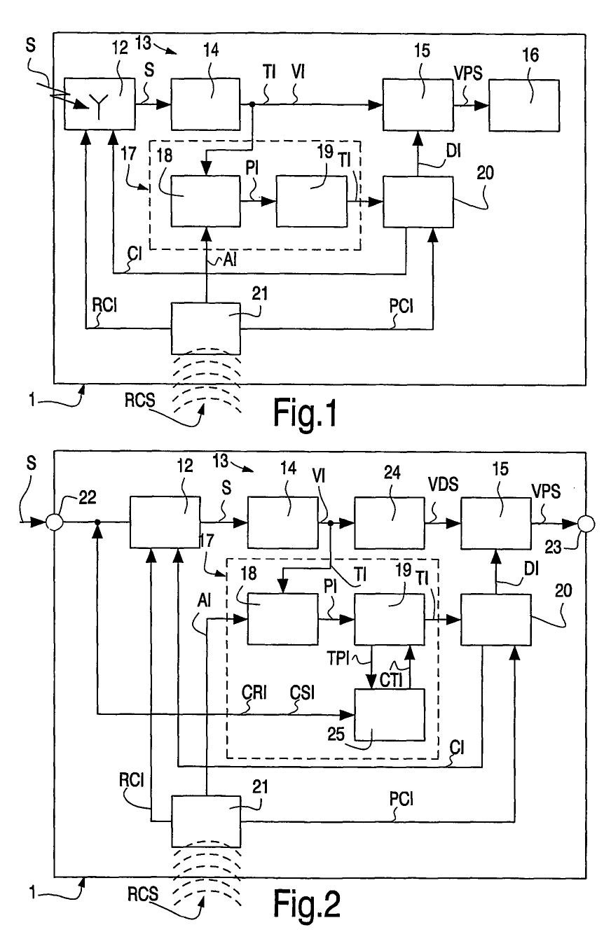

FIG. 1 shows, in a schematic manner in the form of a block circuit diagram, a device in accordance with a first embodiment of the invention.

FIG. 2 shows, in a manner analogous with FIG. 1, a device in accordance with a second embodiment of the invention.

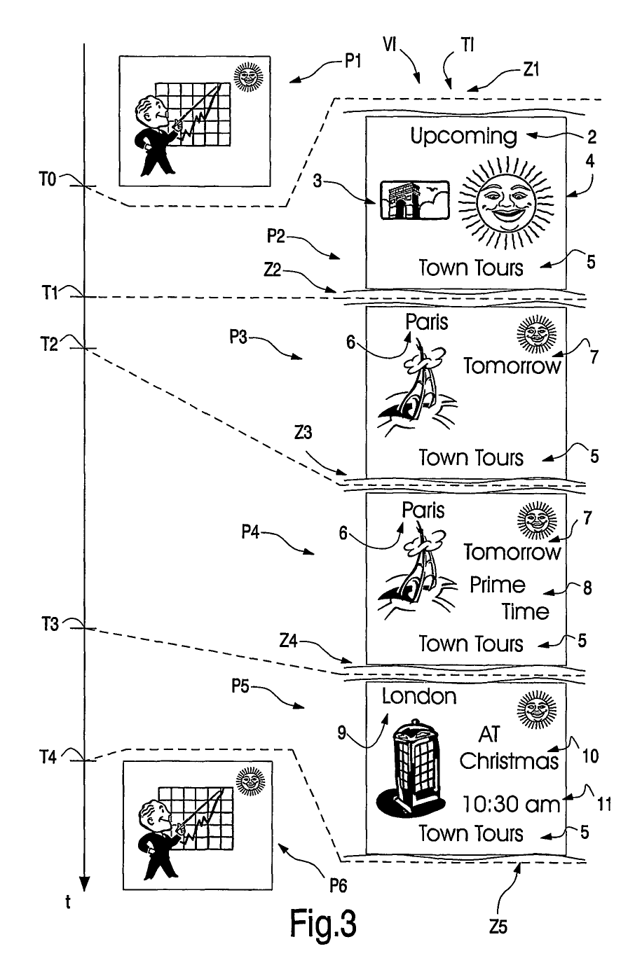

FIG. 3 shows, in the form of a succession of pictures along a time axis, a part of a visually presentable video information over time, which shows sections of text information contained in the visually presentable video information.

FIG. 1 shows a device 1 that realizes a television set and is designed to receive a signal S, namely a television signal. Signal S is emitted by a broadcasting station, not shown in FIG. 1, via a transmission channel—a broadcasting transmission channel in the present case—and can be received by device 1 via a selectable reception channel if the reception channel is coincident with the transmission channel. Signal S represents visually presentable video information VI and text information TI contained in the visually presentable video information VI, which text information TI will be described in greater detail below with reference to FIG. 3.

Video information VI is illustrated in FIG. 3 in the form of a sequence of pictures P1 to P6 along a time axis t. The individual pictures P1 to P6 are contained in video information VI in succession, wherein, however, they do not necessarily have to occur directly adjacent to, i.e. immediately after one another, as indicated by five intermediate areas Z1 to Z5 between the pictures P1 to P6, in which intermediate areas Z1 to Z5, further pictures are present. Before a moment T0 and after a moment T4, video information VI represents a first television program entitled “The Economist”, the subject of which is the economy. The first television program is indicated symbolically, before moment T0 and after moment T4, by means of identical pictures P1 and P6. The first television program is transmitted by the broadcasting station “Smiling Sun” on the transmission channel assigned to this broadcasting station.

At moment T0, the first television program “The Economist” is interrupted by the broadcasting station, and between moments T0 and T4, an announcement—known as a trailer—for a second television program is transmitted to bring the attention of a user of device 1 to this second television program entitled “Town Tours”. The subject of the second television program is towns, wherein, in the present case, the intention is to draw attention to two parts, namely a first part concerning Paris and a second one concerning London. By way of explaining this trailer that is visually presentable to a viewer or user of device 1, the four pictures P2 to P5 are shown as “snapshots” of the trailer between moments T0 and T4 in FIG. 3.

Using first textual information 2 (“Upcoming”) contained in visually presentable video information VI, picture P2 indicates to the viewer that the trailer is merely an advance notification of the second television program, which will be available in full on a future occasion. A first logo 3 for the second television program and a second logo 4 for the broadcasting station are further visible. Also contained and visible in video information VI is second textual information 5, concerning a title of the second television program, namely “Town Tours”.

Picture P3 contains third textual information 6, namely a first name of the town (“Paris”) shown in the first part, which town will be shown in the second television program that can be received in the future. Picture P3 further contains information giving more precise timing details concerning the future availability of the second television program. To this end, fourth textual information 7, namely date information relative to the date of reception of the trailer (“Tomorrow”), is inserted. Following on from picture P3 in terms of time, picture P4 gives a further refinement of the details concerning the future availability of the second television program. To this end, fifth textual information 8, namely relative time information (“Prime Time”) is inserted, indicating that the second television program will be receivable at a prime transmission time, between 20.00 and 21.00, characteristic of the broadcasting station “Smiling Sun”.

Using the trailer, reference is further made, in a relatively short timespan between moments T3 and T4, to the further part, which will be available further in the future, regarding the town of London. To this end, picture P5 contains sixth textual information 9, namely a second name of the town (“London”) shown in the second part, which town will be shown in the second television program that can be received in the future. Contained in the video information in picture P5 simultaneously with sixth textual information 9 are two items of information giving more precise timing details of the future availability of the second television program. To this end, seventh textual information 10, namely the absolute date information (“At Christmas”) and eighth textual information 11, namely the absolute time information (“10.30 a.m.”) are inserted.

For the purpose of receiving signal S and making video information VI available to the user, device 1 shown in FIG. 1 is equipped with reception means 12 and processing means 13, located downstream of reception means 12. Reception means 12 is designed for the channel-selective reception of signal S in a controllable manner as a function of control information CI, which can be supplied to reception means 12, and reception-means setting information RCI for the channel-selective reception of signal S, wherein, using the two information items CI and RCI, a reception channel can be selected at reception means 12. Reception means 12 is further designed to deliver to the processing means 13 an electrical representation of the signal S received via the particular reception channel selected.

Processing means 13 is designed to receive the received signal S and to process signal S and to supply video information VI and the text information TI contained in video information VI, namely textual information items 2, 5, 6, 7, 8, 9, 10 and 11. To this end, processing means 13 is equipped with video-information decoding means 14, video-presentation-signal generation means 15 and presentation means 16. Video-information decoding means 14 is designed to receive signal S and to decode video information VI from signal S and to supply video information VI to video-presentation-signal generation means 15. Video-presentation-signal generation means 15 is designed to receive video information VI and supplementary video information DI, and to generate and supply video-presentation signal VPS, containing both items of information, which is suitable for the joint visual presentation of both information items VI and DI. Presentation means 16 is designed for reception of video-presentation signal VPS and for the visual presentation of video information VI and, if applicable, supplementary video information DI, and, in the present case, is realized by a screen and an electronics system of device 1 assigned to the screen.

Processing means 13 is further equipped with extraction means 17, which is designed to receive video information VI and to extract text information TI from the video information VI and to receive activation information AI and to start the extraction of text information TI from video information VI when the activation information AI is received. To this end, extraction means 17 is equipped with picture storage means 18 and text filtration means 19. Picture storage means 18 is designed to receive video information VI and to store a single picture of video information VI. Picture storage means 18 is further designed to supply picture information PI, representing the picture. Text filtration means 19 is designed to filter picture information PI in respect of the text information TI contained in picture information PI. Text filtration means 19 is further designed to recognize a multiplicity of text specimens in picture information PI, which are relevant for usage of the extracted text information TI in the programming means 20 located downstream of extraction means 17. Examples of the recognizable text specimens that can be given at this point are date formats, such as “YYYY MM. DD.”, DD. MM. YYYY” or “DD. MMM YYYY”, or textual information that enables conclusions as to a specific date information, such as “Tomorrow”, “At Christmas” or “At Santa Claus”. Further examples of recognizable text specimens are time formats, such as “HH MM SS”, “HH:MM am” or “HH:MM pm” or textual time information that enables conclusions as to a specific time, such as “Prime Time”, “Late Night” or “Children's Hour”. It should be expressly stated at this point that the above-mentioned examples of text specimens constitute just a sample of a multiplicity of options.

Text filtration means 19 is accordingly designed to supply the text information TI relevant to the programming means 20, specifically textual information items 7 and 8 and 10 and 11 respectively. It should be mentioned that text filtration means 19 may also be designed to supply the text information TI that is not relevant to programming means 20, specifically textual information items 2, 5, 6 and 9, in order, for example, to make available to the user, at programming means 20, an information item thematically supporting the relevant text information TI, i.e. textual information 7 and 8 and 10 and 11 respectively, for the purpose of checking by the user of device 1.

Programming means 20 is designed for receiving the relevant extracted text information TI and for receiving programming-means setting information PCI and, using the relevant text information TI and/or using programming-means setting information PCI, for the programmable provision of control information CI for the reception means 12, so that, in accordance with programming undertaken on the basis of the relevant text information TI, the desired reception channel can be selected by reception means 12 at a correct or desired moment, i.e. at the correct date and the correct time. Programming means 20 is further designed to generate and provide the visually presentable supplementary video information DI, which represents the relevant text information TI that can be used for the programmable provision of control information CI for reception means 12, and, if applicable, additional information, such as textual information items 2, 5, 6 or 7, so that the particular programming for the programmable provision of control information CI can be visually presented to the user, and can also be checked and/or amended by him.

Device 1 is further equipped with inputting means 21, which is designed in such a way that the activation information AI provided for activation of extraction means 17 can be inputted at device 1, and supplied to the extraction means 17, which is designed to interact, i.e. to receive activation information AI. In the present case, inputting means 21 is realized by remote-control-signal reception/processing means, which is designed to receive a remote control signal RCS, transmitted to device 1 by means of infrared light from a remote control device, not shown in FIG. 1. Using remote control signal RCS, reception-means setting information RCI can also be transmitted to device 1, and a manual selection of the particular reception channel can thus be undertaken at reception means 12. Programming-means setting information PCI can further be transmitted to the device by means of remote control signal RCS, and a manual programming of the programmable provision of control information CI for reception means 12 can thus be undertaken. It should be mentioned at this point that inputting means 21 may also be realized by voice recognition means, which are designed to recognize and process spoken commands. Provision may also be made for information items AI, RCI and PCI to be sent to the device by manual operation of the inputting means 21, which is hereby designed as a keypad.

Using device 1, a method of receiving signal S, which can be received via a selectable reception channel, can also be implemented, wherein, using reception means 12, signal S is selected channel-selectively, in a controllable manner, as a function of the control information CI which can be sent to reception means 12, and is sent to processing means 13. Signal S is processed by processing means 13, and the video information VI, represented by signal S, in which text information TI is contained, is provided. The provided text information TI is further extracted from the visually presentable video information VI by the extraction means 17 contained in processing means 13, and the control information CI is provided for reception means 12 by the programming means 20 downstream of extraction means 17, using the extracted text information TI.

The extraction of the text information TI from video information VI is started at extraction means 17 by means of the reception of activation information AI, wherein, for example, activation information AI is generated between the moments T2 and T3 shown in FIG. 3 by a user of device 1 using a remote control device, and inputted to device 1 via inputting means 21. Using picture storage means 18, picture P4, which is represented in digital form by picture information PI, is hereby stored, and picture information PI is delivered to text filtration means 19.

In accordance with the method, picture information PI is filtered by text filtration means 19 as regards the text information TI contained within picture information PI, and the relevant text information TI filtered from picture information PI is delivered. With the method, fourth textual information 7 “Tomorrow” is recognized by text filtration means 19 as a text specimen enabling a conclusion to be drawn as to a specific date, namely the following day. Fifth textual information 8 (“Prime Time”) is further recognized as a text specimen enabling a conclusion to be drawn as to a specific time, namely the peak transmission time of the “Smiling Sun” broadcasting station, which, in the present case, starts at 20.00 and ends at 21.00 each day. The two textual information items 7 and 8 are recognized by text filtration means 19 as relevant for using the extracted text information TI at programming means 20. The further textual information items 6 (“Paris”) and 7 (“Town Tours”) are recognized as not relevant and are therefore not passed to programming means 20.

For the purpose of a visual confirmation of the programming procedure desired by the user, provision is made in the method for supplementary video information DI, which represents the text information TI that can be used for the programmable provision, i.e. “Tomorrow” and “Prime Time” and a plain-text rendering of tomorrow's date and the timespan corresponding to the peak transmission time in the present case, to be generated by programming means 20, and passed to video-presentation-signal generation means 15. Using video information VI and the supplementary video information DI, video presentation signal VPS, containing the two items of information, is generated and passed on by video-presentation-signal generation means 15, which video presentation signal VPS is suitable for the joint visual presentation of both information items DI and VI and enables the user of device 1 to make a visual check of the programming procedure.

In device 1, the control signal CI for reception means 12 is programmably provided, in accordance with the method, using the available text information TI in the trailer shown in FIG. 3, on the day following the programming, between 20.00 and 21.00, so that the television series “Town Tours” with the part concerning Paris is received channel-selectively by reception means 12.

If, however, the user of the device inputs activation information AI to the inputting means of device 1 for the first time or once again, i.e. a second time, between moment T3 and moment T4 in FIG. 3, then, by analogy with the statements above, control signal CI would be programmably provided for reception means 12 at device 1 at Christmas, at 10.30 am, to enable the reception of the television series “Town Tours” with the part concerning London.

Device 1, as shown in FIG. 2, is realized by a digital set-top box, which differs from device 1 as shown in FIG. 1 as described below.

Device 1 is equipped with a first connection 22 and can be connected at first connection 22 to a cable-television network, wherein both signal S and digital data can be transmitted via the cable-television network for the purpose of communication between device 1 and a data server, which is not shown in FIG. 2. Device 1 is further equipped with a second connection 23, and can be connected at this second connection 23 to a video-presentation-signal processing device arranged externally to device 1 and not shown in FIG. 2, such as a television set or a video recorder, wherein the video presentation signal VPS can be passed, via second connection 23, from device 1 to this video-presentation-signal processing device. Between video-information decoding means 14 and video-presentation-signal generation means 15, device 1 is further equipped with MPEG encoding means 24, which is designed to receive the video information VI decoded from signal S, and to generate and deliver to video-presentation-signal generation means 15 an MPEG-encoded video data stream VDS representing video information VI. In the present case, video-presentation-signal generation means 15 is designed additionally to receive supplementary video information DI for receiving and processing video data stream VDS.

As a component of extraction means 17, device 1 is equipped with picture storage means 18, which, in the present case, is designed to store ten (10) pictures, wherein one single picture of video information VI can be stored per second. In this case, picture information PI represents each of the ten (10) pictures. Text filtration means 19 is designed to filter picture information PI as regards the text information TI contained in picture information PI for each of the ten (10) pictures. It should be mentioned at this point that a quantity other than ten (10) pictures, such as three (3) pictures or twenty (20) pictures, may be provided, wherein it has proved advantageous if the particular quantity of pictures corresponds to the length of a trailer, measured in seconds, since it is ensured with a high degree of probability as a result, that the text information TI contained in video information VI can be used optimally for the purposes of programming means 20. In the present case, extraction means 17 is designed in such a way that the storing of ten (10) pictures is started when it receives the activation information AI.

Accordingly, using the method in the present case, ten (10) pictures of visually presentable video information VI are stored by picture storage means 18. The picture information PI, representing the ten (10) pictures is further passed to text filtration means 19. Applied to the situation shown in FIG. 3, the advantage is obtained, through the provision of this measure, that in the event that activation information AI is inputted in due time—e.g. between moments T0 and T1—both the text information TI located between moments T2 and T3, and the text information TI located between moments T3 and T4 can be made available to text filtration means 19.

It should be mentioned in this connection that storage means 18 may also take the form of a toroidal-core memory, using which a certain quantity of pictures of the video information VI are permanently available, synchronously with video information VI, and that, irrespective of the particular moment of the inputting of activation information AI, picture information PI represents all the pictures located in the toroidal-core memory. This gives rise to the advantage that even pictures that, with respect to the moment of the inputting of activation information AI, arose in the past are available at text filtration means 19, and therefore text information TI contained in the pictures, to which the reaction of a user of device 1 was delayed, can also be used for the purposes of programming means 20.

In the present case, text filtration means 19 is designed to recognize, taking account of textual information items 6 and 9, that the text information TI relevant to programming means 20 concerns two parts that can be differentiated from one another. Accordingly, a relevant text information TI relating to the particular part, i.e. firstly the textual information items 7 and 8, and secondly the textual information items 10 and 11, can be passed by text filtration means 19 to programming means 20.

In addition to filtering picture information PI as regards the text information TI contained in picture information PI, text filtration means 19 is also designed to recognize that the text information TI filtered from picture information PI is so incomplete that the programmable provision of control information CI for reception means 12 is not guaranteed at programming means 20. As a result of recognizing an incomplete text information of this kind, text filtration means 19 is designed to pass on at least a part of the text information TI filtered from picture information PI as partial text information TPI.

Extraction means 17 is further equipped with text-information supplementation means 25, which is designed to receive partial text information TPI from text filtration means 19, and to transmit partial text information TPI as a component of a communication transmission information CSI, which can be generated and delivered using it. In addition to partial text information TPI, communication transmission information CSI also contains a first address for addressing device 1 in order to made it addressable during a communication via the Internet, and a second address to address the data server available on the Internet, which data server is designed to receive the partial text information TPI, to evaluate it and, if applicable, supplement it in order to ensure the programmable provision of control information CI at programming means 20. In the present case, the data server is realized by an EPG (“Electronic Programming Guide”) server. Text-information supplementation means 25 is further designed to receive a communication-reception information CRI from the data server, and to deliver to text filtration means 19 a supplementation text information CTI, which is contained in communication-reception information CRI and corresponds to partial text information TPI. It should be mentioned at this point that text-information supplementation means 25 may also be designed to deliver multiple items of supplementation text information CTI corresponding to partial text information TPI if, for example, on the basis of partial text information TPI, no clear supplementation of partial text information TPI by the data server is possible, and the data server communicates multiple possible items of supplementation text information CTI to device 1 using communication-reception information CRI.

Text filtration means 19 is designed to receive supplementation text information CTI from text-information supplementation means 25 and to compile the relevant text information TI by supplementing partial text information TPI with the received supplementation text information CTI. In the event that multiple items of supplementation text information CTI are present, provision is made for the multiple items of text information TI present to be made available to a user of device 1, using supplementary video information DI, for the purpose of making a selection.

A circumstance representing the situation described above exists when, for instance, the trailer shown in FIG. 3 contains only pictures P2 and P3, and accordingly contains no specific, or filterable, time information.

In a case of this kind, it is recognized using the method, by means of extraction means 17, specifically by means of text filtration means 19, that the text information TI filtered from picture information PI, namely the textual information 2, 5, 6 and 7, is so incomplete that, at programming means 20, the programmable provision of control information CI for reception means 12 is not guaranteed. If incomplete text information TI of this kind is recognized with the method, at least part of the text information TI filtered from picture information PI, which is textual information 5, 6 and 7 in the present case, is delivered to text-information supplementation means 25 as partial text information TPI.

In accordance with the method, partial text information TPI is transmitted by text-information supplementation means 25 as a component of communication transmission information CSI via a communication channel, which communication channel takes the form of the cable television network, which is connected to the Internet. A supplementation text information CTI corresponding to partial text information TPI is transmitted from the addressed data server, as a component of communication reception information CRI, via the communication channel to device 1, and received at device 1 by partial text-information supplementation means 25. The supplementation text information CTI is subsequently delivered from text-information supplementation means 25 to text filtration means 19.

Under the method, the relevant incomplete text information TI is further formed, using text filtration means 19, by supplementing partial text information TPI with the received supplementation text information CTI, specifically by a supplementation of textual information 7 with the textual information “20.00 to 21.00” relevant to the programmable provision of control information CI, and delivered to programming means 20 as the complete, relevant text information TI.

This gives rise to the advantage that, even if text information TI that is incomplete for the programmable provision of control information CI is present in video information VI, complete text information TI, as necessary for the programmable provision of control information CI, can be delivered to programming means 20.

In the event that a multiplicity of items of supplementation text information CTI corresponding to partial text information TPI are present, it is provided under the method that the multiplicity of items of supplementation text information CTI are used to generate a multiplicity of items of complete text information TI, and that the opportunity is offered to a user of device 1, using supplementary video information DI, to select the text information TI that, in his opinion, is appropriate for the programmable provision of control information CI.

It should be mentioned that device 1 may also be equipped with storage means designed to store video data stream VDS. Storage means of this kind may be realized by, for instance, a hard disk memory or a semiconductor memory. It may further be provided that device 1 is also equipped with data-carrier access means designed for accessing an exchangeable data carrier, such as a DVD or a CD+RW or a semiconductor-based memory card, for the purpose of storing the video data stream VDS on a data carrier.

1. A device (1) for receiving a signal (S) that can be received via a selectable reception channel, which signal (S) represents visually presentable video information (VI) and text information (TI) contained in the visually presentable video information (VI),
wherein reception means (12) is provided, which is designed for the channel-selective reception of the signal (S) in a controllable manner as a function of control information (CI) that can be supplied to the reception means (12), and
wherein downstream of the reception means (12) is provided processing means (13), which is designed to process the received signal (S) and to provide the video information (VI) and the text information (TI), and
wherein the processing means (13) is equipped with extraction means (17), which is designed to extract the text information (TI) from the visually presentable video information (VI), and
wherein programming means (20) is provided, which is located downstream of the extraction means (17) and, using the extracted text information (TI), is designed for the programmable provision of the control information (CI) for the reception means (12).

2. A device (1) as claimed in claim 1,
wherein the extraction means (17) is equipped with picture storage means (18), which is designed to store at least one picture (P2, P3, P4, P5) of the visually presentable video information (VI) and to supply picture information (PI), representing the at least one picture (P2, P3, P4, P5), and
wherein the extraction means (17) is equipped with text filtration means (19), which is designed to filter picture information (PI) in respect of the text information (TI) contained in picture information (PI) and to supply the text information (TI) filtered from the picture information (PI).

3. A device (1) as claimed in claim 2, wherein the text filtration means (19) is designed to recognize at least one text specimen in picture information (PI), which is relevant for usage of the extracted text information (TI) in the programming means (20).

4. A device (1) as claimed in claim 2,
wherein the extraction means (17) is equipped with text-information supplementation means (25), which is designed to receive partial text information (TPI) from text filtration means (19), and to transmit partial text information (TPI) via a communication channel and to receive at least one item of supplementation text information (CTI), corresponding to partial text information (TPI), via the communication channel, and to supply the received supplementation text information (CTI) to the text filtration means (19), and
wherein the text filtration means (19) is designed to recognize that the text information (TI) filtered from picture information (PI) is so incomplete that the programmable provision of control information (CI) for reception means (12) is not guaranteed at programming means (20), and which text filtration means (19), as a result of recognizing an incomplete text information (TI) of this kind, is designed to pass on at least a part of the text information (TI) filtered from picture information (PI) as partial text information (TPI) to text-information supplementation means (25), and which text filtration means (19) is designed to receive the supplementation text information (CTI) from the text-information supplementation means (25) and to compile the text information (TI) by supplementing partial text information (TPI) with the received supplementation text information (CTI).

5. A device (1) as claimed in claim 1,
wherein the device is equipped with inputting means (21), which is designed in such a way that activation information (AI), which is provided to activate extraction means (17) can be inputted at the device, and
wherein the extraction means (17) is designed to interact with inputting means (21) and, if activation information (AI) is present, to start the extraction of text information (TI) from the video information (VI).

6. A device (1) as claimed in claim 1,
wherein the programming means (20) is designed to generate and provide the visually presentable supplementary video information (DI), which represents the text information (TI) that can be used for the programmable provision of control information (CI) for reception means (12), and
wherein video-presentation-signal generation means (15) is provided, which, using video information (VI) and supplementary video information (DI), is designed to generate and supply video-presentation signal (VPS), containing both items of information (VI, DI), which is suitable for the joint visual presentation of both information items (VI, DI).

7. A method for receiving a signal (S) that can be received via a selectable reception channel, which signal (S) represents visually presentable video information (VI) and text information (TI) contained in the visually presentable video information (VI),
wherein, using reception means (12), the signal (S) is received channel-selectively, in a controllable manner, as a function of control information (CI) supplied to the reception means (12), and
wherein the signal (S) is processed by processing means (13) located downstream of the reception means (12), and the video information (VI) and the text information (TI) are supplied, and
wherein the text information (TI) is extracted from the supplied visually presentable video information (VI) by extraction means (17) contained in the processing means (13), and
wherein the control information (CI) for the reception means (12) is provided programmably by the programming means (20) located downstream of the extraction means (17), using the extracted text information (TI).

8. A method as claimed in claim 7, wherein at least one picture (P2, P3, P4, P5) of the visually presentable video information (VI) is stored by extraction means (17), and picture information (PI), representing the at least one picture (P2, P3, P4, P5), is generated, and the picture information (PI) is filtered in respect of the text information (TI) contained in picture information (PI) and the text information (TI) filtered from the picture information (PI) is supplied.

9. A method as claimed in claim 8, wherein, during the filtering of picture information (PI), at least one text specimen is recognized in picture information (PI) which is relevant for usage of the extracted text information (TI) in the programming means (20).

10. A method as claimed in claim 8,
wherein it is recognized by extraction means (17) that the text information (TI) filtered from picture information (PI) is so incomplete that the programmable provision of control information (CI) for reception means (12) is not guaranteed at programming means (20), and wherein, when an incomplete text information (TI) of this kind has been recognized, at least a part of the text information (TI) filtered from picture information (PI) is transmitted as partial text information (TPI) via a communication channel, and at least one item of supplementation text information (CTI) corresponding to the partial text information (TPI) is received via the communication channel, and
wherein the text information (TI) is compiled by supplementing partial text information (TPI) with the received supplementation text information (CTI).

11. A method as claimed in claim 7, wherein the extraction of text information (TI) from video information (VI) is started at extraction means (17) when activation information (AI) is inputted to device (1).

12. A method as claimed in claim 7,
wherein supplementary video information (DI), which represents the text information (TI) that can be used for the programmable provision of control information (CI) for reception means (12), is generated and provided by programming means (20), and
wherein, using video information (VI) and supplementary video information (DI), video-presentation signal (VPS), containing both items of information (VI, DI), which is suitable for the joint visual presentation of both information items (VI, DI) is generated and supplied by video-presentation-signal generation means (15).
